(19) United States
(12) Patent Application Publication
(10) Pub. No.: US 2006/0141424 A1
(43) Pub. Date: Jun. 29, 2006

(54) Method for teaching or improving reading-related skills

(75) Inventors: Leslie Bockol, New York, NY (US); Shari Kaufman, Westport, CT (US)

Correspondence Address: HEDMAN & COSTIGAN P.C., 1185 AVENUE OF THE AMERICAS, NEW YORK, NY, 10036, US

(73) Assignee: Innovative USA, Inc.

(21) Appl. No.: 11/025,036

(22) Filed: Dec. 29, 2004

(51) Int. Cl. G09B 19/06; G09B 19/08

(52) U.S. Cl. 434/157

(57) ABSTRACT

A method for teaching and improving reading-related skills, spelling, vocabulary building, fluency and reading comprehension by combining comic books or comic magazines with phonics words designed to teach and improve a student's skills in these areas.

### FIELD OF INVENTION

The present invention relates to a method for teaching or improving one or more of early learning reading skills, phonics skills, spelling, vocabulary building, and building fluency and reading comprehension. More particularly, the present invention relates to a method that will motivate and encourage learning in these areas by combining two existing but previously believed unrelated formats—phonics based learning and the comic book genre.

### BACKGROUND OF THE INVENTION

Phonics is a method of teaching early reading skills, pronunciation and spelling based on the phonetic interpretation or decoding of letters and letter groups. In traditional phonics-based instructional materials, each sound is represented by the letters that form the sound, a word using the sound and a picture of an object, the name of which includes the sound. For example, the “ou” sound may be illustrated on a flash card or other object by the letters “ou” and the word “mouse.” Repetitive reading, hearing and speaking of the vowels, consonants, blends and combinations assists in the learning process.

One problem often encountered in teaching reading through phonics skills, or the skills of spelling, vocabulary building, and reading comprehension, is that the student becomes bored or discouraged. Even for students who have a desire to learn such skills, traditional materials provide no motivation to engage in the repetitive, dreary learning process. Compounding the problem is the fact that compelling narrative content is nonexistent or perfunctory at best in traditional teaching materials; content is traditionally subservient to the skills being exercised. Further, repetition of the decoding process, and not the more important aspects of motivation to read and learn or reading comprehension, is at the heart of traditional phonics materials.

Comics are books or magazines made up of pictures and text that tell a story. The liberal use of pictures in comic books and magazines inspire children and even adults to read. Because the pictures convey much of the narrative action and mood, less text is necessary, making comics especially appealing for readers who are reluctant to read—those who lack confidence or fluency in their reading skills. The traditionally casual, recreational, and high-interest nature of comics also makes them a favorite with those who require special motivation to read. Further, the format lends itself equally well to independent reading and partner reading between or among peers.

Despite these useful characteristics, comics as traditionally crafted have been useless as a teaching tool for beginning readers, for at least three integral reasons. First, the actual verbiage of the text previously has been written with no regard for the limited, phonetically-based reading skills of beginning readers. Second, the fast-paced story lines generally require the reader to make conceptual leaps based on synthesizing art, text, and deductive logic, in a way that is inappropriate for readers who still require considerable degrees of concentration in order to simply decode text. Third, the graphic style of the page arrangement has traditionally been too chaotic for beginning readers to comprehend without concentrated effort, and no conscientious effort has been made by the creators to utilize the art as a clear prompt or visual cue for words that are difficult to decode phonetically.

Accordingly, although it previously was unknown in the genre, the present inventors have discovered that comics, if altered in at least three significant and integral ways, can be made into an excellent vehicle for teaching and improving one or more of phonics skills, early learning reading skills, spelling, vocabulary building, fluency and reading comprehension.

First, the text carefully may be calibrated to exercise fundamental phonics skills, largely avoiding words that do not follow phonics rules. This allows beginning readers to practice skills that are within their grasp and gain reading fluency, without causing undue frustration by requiring reading skills they have not yet acquired. The rare words that do not follow phonics rules may be called out in the back of the book as “story words” (which are words accompanied by strong visual cues in the story pages) or as “sight words” (which are words such as “there” and “were” that are used with high-frequency in the English language, and which standard school curriculums recognize as necessary for early readers to memorize).

Second, the story lines may be constructed to allow easy comprehension, with step-by-step development tracked explicitly by both text and artwork. So doing allows readers easily to follow the logical development of the stories, even when their decoding of the text may be halting because of their limited fluency.

Third, the graphic style of page layout may be modified so that the sequence of events is clear, easy to follow and eliminates reader frustration or confusion. Further, the artwork itself may be adapted so that clear prompts and visual cues are available in the pictures for readers who may be struggling to decode specific words.

With such changes, the comic book format becomes an ideal tool for teaching reading through phonics as well as teaching and improving spelling, vocabulary building, fluency and reading comprehension.

Another advantage of combining comics with traditional phonetic teaching methods is that the method prevents students from becoming bored or discouraged with the learning process. That is, the high-interest nature of the comic format stories, which is absent from traditional material, will motivate repeated readings, which in turn will reinforce phonics principles and increase beginning readers' fluency with such carefully calibrated skills as decoding vowels, consonants, and consonant blends as well as spelling, vocabulary building, and reading comprehension.

Moreover, the fact that comics traditionally are targeted towards an older readership (pre-teen, teen, and young adult) makes the present invention a useful method for both older and younger beginning readers. Older beginning readers will not be as likely to reject the comic format as they are to reject traditional teaching materials, which are not engaging and extremely simplistic in their content. The present method similarly will motivate younger beginning readers, who often aspire to the reading materials used by adults and older siblings.

Prior art methods and systems of instruction in the aforementioned areas have various drawbacks including that that they are difficult or complicated, can bore or discourage the user, involve expensive equipment, or are limited in their appeal. The prior art subject to all or some of these drawbacks includes the following:

U.S. Pat. No. 6,322,367, which discloses a method and materials for teaching the phonetic code and repairing self-esteem. The steps in the method involve diagnostic testing, motivational talks, and the use of informational sheets and worksheets.

U.S. Pat. No. 6,227,863, which discloses a phonics training computer system for teaching, spelling and reading. The system includes a computer with a digitally stored dictionary of phonetic sounds and words and an image library of pictures corresponding to the dictionary.

U.S. Pat. No. 4,713,008, which discloses a method for teaching reading, phonics and spelling by teaching a set of sound symbols as an aid to instruction in these fields.

The internet sites at increaseiq.com/phonics_comic_books.htm and raiseiq.org/phonics_comic_books, which offer for sale tutorial CDs to teach reading to babies.

No prior art, however, provides a method for teaching phonics skills, reading skills, spelling, vocabulary building, fluency and reading comprehension that motivates the reader to learn, is easy to use, does not require expensive equipment to produce or use and can be used by students of all ages in the areas of phonics, reading, spelling, vocabulary building, and reading comprehension. In this regard, the present invention solves a long felt need in the art.

### SUMMARY OF THE INVENTION

As used in describing and claiming the present invention, the term “phonics” shall mean the form of instruction that cultivates the understanding and use of the alphabetic principle that there is a predictable relationship between phonemes (the sounds in spoken language) and graphemes (the letters that represent those sounds in written language) and that this information can be used to read or decode words. See, e.g., http://www.nifl.gov/partnershipforreading/glossary/glossary.html.

As used in describing and claiming the present invention, the phrases “comic book” or “comic magazine” or “comics” shall mean the art form that features a series of static images in fixed sequence incorporating written text to tell a story. See, e.g., http://en.wikipedia.org/wiki/Comics.

The present invention concerns a method of teaching or improving one or more of early learning reading skills, phonics skills, spelling, vocabulary building, fluency and reading comprehension.

Thus, it is an object of the present invention to provide a method that will motivate and encourage learning in these areas by combining the best of two existing formats—phonics based learning and the comic book genre.

It is a further object of the present invention to provide a method that fosters the repetitive reading, hearing and speaking of the vowels, consonants, blends, words and combinations that assist in the learning process in these areas.

It is another object of the present invention to provide a method that allows a student to learn with less time and effort than is associated with other such methods.

It is another object of the present invention to provide a method that does not require expensive equipment to produce or use.

It is another object of the present invention to provide a method of learning to read that can be used by students of all ages.

These and other objects and advantages of the present invention will become apparent from a study of the following specification and the accompanying drawings.

### BRIEF DESCRIPTION OF THE DRAWINGS

FIG. 1 depicts a perspective view of one example of a book useful in the method of the present invention.

FIG. 2 depicts an example of two lists of focus words that may be provided with the book that is useful in the method of the present invention.

FIG. 3 depicts an exemplary comic page that is useful in the method of the present invention.

FIG. 4 depicts an example of the instructions that may be provided with the comic that is useful in the method of the present invention.

### DETAILED DESCRIPTION OF THE INVENTION

The persons benefiting directly from this invention have been referred to as “students.” However, although the term “student” may convey the mental image of a young person or young adult who is enrolled in classes, as used herein the term is not so limited. The term is intended to encompass anyone seeking to learn or in need of learning to read. Students may include children, parents, grandparents, or anyone and may range in age from three to one hundred three. Likewise, the term “teacher” as used herein is not limited to a teacher by vocation but includes anyone who uses this invention for instructional purposes. The term “teacher” may include children, parents, grandparents, or anyone who uses this invention for instructional purposes.

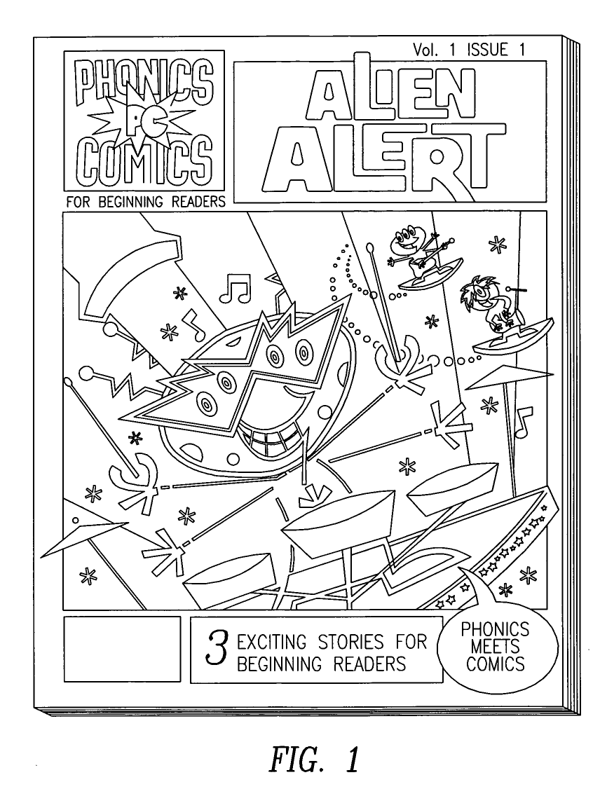

FIG. 1 depicts a perspective view of one example of a book useful in the method of the present invention.

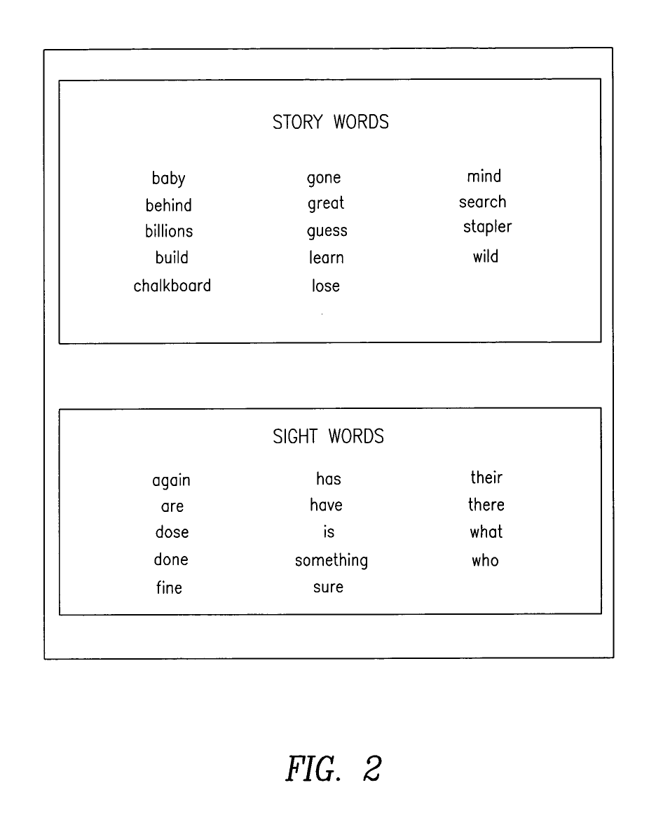

FIG. 2 depicts an example of two lists of focus words that may be provided with the book that is useful in the method of the present invention. Depicted are two lists of the focus words. The first list contains “story words” that pose a particular challenge to readers' skills. The second list contains “sight” words derived from generally accepted lists of high-usage English-language words, which educational curriculums expect children to learn to read “by sight” despite the fact that the words do not adhere to phonics rules.

Although FIG. 2 depicts story words and sight words, other kinds of focus words are within the scope of the present invention. For example, the focus words may comprise nouns, verbs, adjectives and/or adverbs or any combination thereof. Further, the focus words may be related to one another by a common theme. Also, the focus words may comprise any group of letters, symbols or words useful for teaching and improving reading skills, phonics skills, spelling, vocabulary building, and reading comprehension.

The focus words depicted in FIG. 2 are printed on the inside back cover of the comic book or magazine. However, the focus words may be printed on the front cover, back cover and/or on a page of the book or magazine. The list may also be separate from, or removably attached to, the book or magazine.

In addition, although FIG. 2 depicts two lists of focus words, one list or two or more lists may be employed. The length of the list or the number of lists as well as the number of focus words used may vary. These variations may be dependent upon, inter alia, the level of the student to whom the method is directed, and/or the skill being taught or improved and/or the characteristics of the comic being employed.

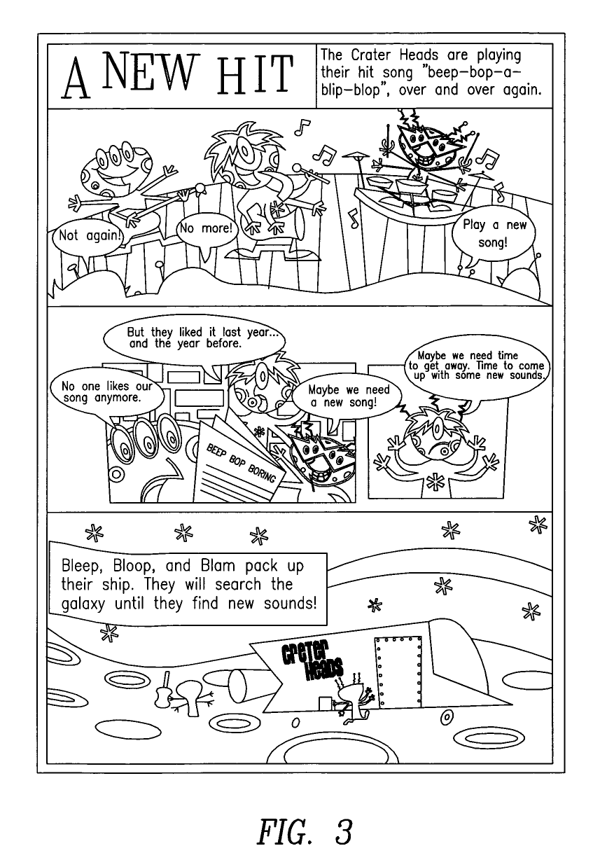

FIG. 3 depicts an exemplary page that is useful in the method of the present invention. Therein is shown a page from a comic book or magazine employing several of the words from the focus lists depicted in FIG. 2.

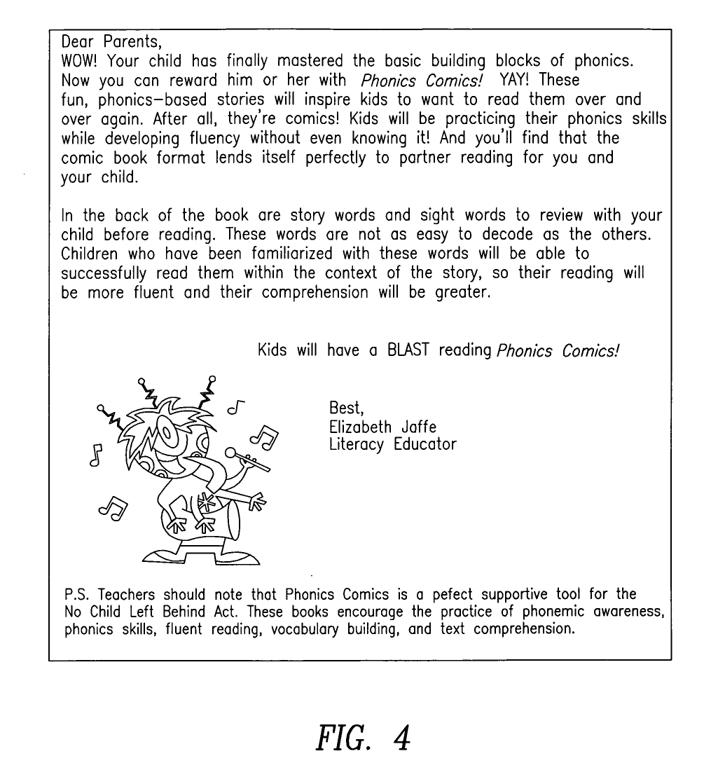

FIG. 4 depicts one example of instructions that may be provided to a teacher or student that is useful in the method of the present invention. Therein, the teacher, in this case a parent, is directed to review the focus words with the student, in this case a child, before the comic book or magazine is read by or with the student so as to increase reading fluency and reading comprehension. The instructions could also be provided in the form of a booklet, or an audio or visual means such as an audio tape, an audio CD, a computer disk, computer CD, a DVD, a videotape, any combination thereof or other means known to those skilled in the art.

One step in the method is providing a student with at least one list of focus words. Another step is directing the student to review and/or study the list of focus words. These steps allow the student to familiarize himself or herself with the letters, symbols or words useful for teaching and improving the phonics skills, reading skills, spelling, vocabulary building and/or reading comprehension (with or without the assistance of a teacher) to which the story or stories in the comic are directed.

The method also comprises the step of providing the student with a comic book or comic magazine with words and pictures wherein a portion of said words are on the list(s) of focus words. This step motivates the student to read and/or to partner read with, between or among peers, children, parents, other students and/or teachers. The step also fosters the repetitive reading, hearing and speaking of the vowels, consonants, blends, combinations and words that assists in the process of learning phonics skills, reading skills, spelling, vocabulary building, and reading comprehension. Also, because people find comic books fun and interesting, this step prevents the student and/or teacher from becoming bored or discouraged with learning and/or teaching the skills in the aforementioned areas.

Additional steps in the method may include directing a student and/or teacher to read the focus words aloud. This may be accomplished by providing such directions or instructions to either the student and/or teacher in or with the comic book or comic magazine. A purpose of this step may be to reinforce the reading, hearing and speaking of the vowels, consonants, blends, combinations and words that assists in the process of learning phonics skills, reading skills, spelling, vocabulary building and reading comprehension.

The method also may include the step of providing an audio or visual content such as an audio tape, an audio CD, a computer disk, a computer CD, a DVD, a videotape or any combination thereof related to a lesson, story or other aspect of the method.

The method also may include the step of directing the student and/or teacher to read the comic book, comic magazine or portion thereof aloud. Further, the method may also comprise the step of directing partner reading between or among students, peers, children, parents and/or teachers. Again, one purpose of such steps is to reinforce the repetition and/or reading, hearing and speaking of vowels, consonants, blends, combinations and words that assists in the process of learning phonics skills, reading skills, spelling, vocabulary building, and reading comprehension.

Because the phonics are in the form of a comic book or magazine, the use of the pictures in combination with the entire story in the book or magazine provides amusement while reading, such that the student may not even realize that he or she is being taught. Further, the comic may contain more than one story, with each story providing the same lesson (or reinforcement) or a different lesson. Further, because of the comic book story format of the present invention, the present invention readily is adaptable to using licensed characters that are familiar to the readers and/or students. Such an embodiment further enhances the enjoyment of the reader because the characters will be known to the reader. Even further, such an embodiment provides for excellent marketing opportunities for the comic book or magazine format of the present invention. The method is also readily adaptable to teaching or improving foreign language skills. In such an embodiment, it is envisioned that the focus words could include words in a language other than that which comprises other text.

All of the above referenced patents are incorporated herein by reference. While this invention has been described with reference to specific embodiments thereof, it is not limited thereto. Instead, the claims that follow are intended to be construed to encompass not only the forms and embodiments of the invention shown and described, but also such other forms and embodiments and such variants and modifications thereof without departing from the spirit and scope of the present invention as may be ascertained from the foregoing description and accompanying drawings.

I claim:

1. A method of improving, reading skills, reading fluency, vocabulary building, or reading comprehension comprising combining the concepts of phonics with the concept of comic books, wherein at least fifty percent of the words contained said comic book are phonics words.

2. A method as defined in claim 1 wherein said method further comprises providing a student with at least one list of focus words.

3. The method of claim 1 wherein said focus words comprise phonics words.

4. The method of claim 1 wherein said focus words comprise sight words.

5. The method of claim 1 wherein said focus words comprise story words.

6. The method of claim 1 wherein said method further comprises directing the student to review and/or study the list of focus words.

7. The method of claim 1 wherein said method further comprises directing the student and/or teacher to read the comic book, comic magazine or part thereof aloud.

8. The method of claim 1 wherein said method further comprises directing partner reading between or among students, peers, children, parents and/or teachers.

9. The method of claim 1 wherein at least eighty percent of the words contained in said comic book are phonics words.

10. The method of claim 9 wherein at least ninety percent of the words contained in said comic book are phonics words.

11. The method of claim 2 wherein said book or magazine contains more than fifty percent focus words from said list.

12. The method of claim 2 wherein said student is provided with two lists of focus words, wherein the first list of focus words comprise phonics words and the second list of focus words comprise sight words.

13. The method of claim 6 wherein said directions are on an audio or visual means such as an audio tape, an audio CD, a computer disk, computer CD, a DVD, a videotape or combination thereof.

14. The method of claim 1 wherein said method further comprises providing audio or visual content such as an audio tape, an audio CD, a computer disk, a computer CD, a DVD, a videotape or combination thereof.

15. An improved comic book or magazine comprising words, the improvement comprising wherein at least fifty percent of the words are phonics words.

16. An improved comic book or magazine as defined in claim 15 wherein said comic book or magazine further comprises at least one list of focus words.

17. An improved comic book or magazine as defined in claim 15 wherein at least eighty percent of the words are phonics words.

18. An improved comic book or magazine as defined in claim 15 wherein at least ninety percent of the words are phonics words.

19. The improved comic book or magazine of claim 16 wherein said book or magazine further comprises directing the student to review and/or study the list of focus words.

20. The improved comic book or magazine of claim 15 wherein said book or magazine further comprises directions to the student and/or teacher to read the comic book, magazine or part thereof aloud.

21. The improved comic book or magazine of claim 15 wherein said book or magazine further comprises direction to the user to partner read between or among students, peers, children, parents and/or teachers.

22. The improved comic book or magazine of claim 16 wherein said book comprises two lists, the first list comprising phonics words and the second list comprising sight words.

23. The method of claim 2 wherein said at least one list of focus words comprise words in a foreign language.

24. The improved comic book or magazine of claim 16 wherein said list of focus words comprises words in a foreign language.
